(19) United States
(12) Patent Application Publication
(10) Pub. No.: US 2024/0106148 A1
(43) Pub. Date: Mar. 28, 2024

(54) TWO-PART ELECTRICAL PIN-CONTACT ASSEMBLY

(71) Applicant: TE Connectivity Germany GmbH, Bensheim (DE)

(72) Inventors: Fabian Waldsauer, Woert (DE); Andreas Oettle, Woert (DE); Stefan Raab, Woert (DE)

(21) Appl. No.: 18/470,832

(22) Filed: Sep. 20, 2023

(30) Foreign Application Priority Data
Sep. 22, 2022 (DE) 102022124426.1

(51) Int. Cl. H01R 13/434; H01R 13/05

(52) U.S. Cl. CPC H01R 13/434; H01R 13/05; H01R 2201/26

(57) ABSTRACT

A two-part electrical pin-contact assembly, in particular a nano or pico pin-contact assembly for an electrical plug connection in the automotive sector, is provided. The two-part electrical pin-contact assembly includes a pin-contact device extending in a longitudinal direction and a contact body extending in the longitudinal direction. The pin-contact device is secured in the contact body by a primary locking and a secondary locking.

### CROSS REFERENCE TO RELATED APPLICATIONS

This application claims the benefit of DE Application No. 102022124426.1 filed 22 Sep. 2022, the subject matter of which is herein incorporated by reference in its entirety.

### BACKGROUND OF THE INVENTION

The subject matter herein relates to electrical contact assemblies.

In the electrical sector (electronics, electrical engineering, electrics, electrical power engineering, etc.), a large number of electrical connector devices or connector assemblies, socket, pin and/or hybrid connectors, etc.—hereinafter referred to as (electrical) connectors (also: mating connectors)—are known, which are used to transmit electrical currents, voltages, signals and/or data with a wide range of currents, voltages, frequencies and/or data rates. In the low-, medium- or high-voltage and/or current range, and especially in the automotive sector, such connectors have to ensure transmission of electrical power, signals and/or data permanently, repeatedly and/or after a comparatively long period of inactivity for a short time in mechanically loaded, warm, possibly hot, contaminated, humid and/or chemically aggressive environments. Due to a wide range of applications, a large number of specially designed connectors are known.

Such a connector (also: electrical entity) and, if applicable, its associated (for example in the case of a connector device or connector assembly) or superordinate (for example in the case of a connector assembly) housing can be installed on an electrical line, a cable, a cable harness etc.—hereinafter referred to as an assembled (electrical) cable (also: electrical entity)—, or on/in an electrical assembly or device, such as on/in a housing, on/in a punching grid, on/in a printed circuit board etc., a (power) electrical, electro-optical or electronic component or a corresponding aggregation, etc. (also: electrical entity).

If a connector (with/without housing) is located on a cable, a line or a wiring harness, it is also referred to as a flying (plug) connector or a plug, socket or coupling; if it is located on/in an electrical, electro-optical or electronic component, aggregation, etc., it is also referred to as a connector assembly, such as a (recessed/surface-mounted) connector, a (recessed/surface-mounted) plug or a (recessed/surface-mounted) socket. Furthermore, a connector on such an assembly is often also referred to as a (plug) receptacle, pin connector, pin strip or header.—In the context of electrical power engineering (generation, conversion, storage and transport of electrical power current in electrical grids, preferably with three-phase high-voltage transmission), reference is made here to cable fittings because of their comparatively complex structure.

Such a connector must ensure a faultless transmission of electricity, wherein mutually corresponding and partially complementary connectors (connector and mating connector) usually have locking assemblies and/or fastening assemblies for permanently but usually releasably locking and/or fastening the connector to/in the mating connector or vice versa.—Furthermore, an electrical connection assembly for a connector, for example comprising or at least having: an actual contact device (terminal; usually materially formed in one piece or integrally, for example a (crimp) contact element, etc.) or a contact assembly (terminal; usually formed in one piece and in multiple parts or two parts, or materially formed in one piece, for example a (crimp) contact assembly), must be securely accommodated therein.

Efforts are constantly being made to improve electrical terminals, and thus also two-part electrical contact assemblies, and to design them more robustly as installation spaces become smaller and smaller, as well as to design and/or manufacture them more cost-effectively. There is a need for a reliable and cost effective two-part pin-contact assembly.

### BRIEF DESCRIPTION OF THE INVENTION

In one embodiment, a two-part electrical pin-contact assembly, in particular a nano or pico pin-contact assembly for an electrical plug connection in the automotive sector, is provided. The two-part electrical pin-contact assembly includes a pin-contact device extending in a longitudinal direction and a contact body extending in the longitudinal direction. The pin-contact device is secured in the contact body by a primary locking and a secondary locking.

One or more objects are solved by means of a two-part, electrical pin-contact assembly, in particular a nano or pico pin-contact assembly for an electrical plug connection in the automotive sector; and by means of an electrical entity, in particular for the automotive sector, according to the independent claims.—Advantageous developments, additional features and/or advantages of the subject matter herein can be found in the dependent claims and the following description.

In various embodiments, the pin-contact assembly includes a pin-contact device extending in a longitudinal direction (first part of the two-part pin-contact assembly) and a contact body extending in said longitudinal direction (second part of the two-part pin-contact assembly), wherein the pin-contact device is secured at/in the contact body, and the pin-contact device is secured at/in the contact body by means of an established primary locking and an established secondary locking.—The secondary locking can be formed at/in the pin-contact assembly in such a way that, in the event of a failure of the primary locking, the secondary locking takes over a task or purpose of the primary locking.

The primary locking can have a materially bonded connection between the pin-contact device and the contact body. In addition to a welded connection, cf. below, this can also be a soldered connection or a possibly electrically conductive adhesive connection. The secondary locking can have a mechanical seating connection between the pin-contact device and the contact body. A seating connection, cf. in the following, can be understood to mean, for example, a contact device stop or a locking connection.

The primary locking can have a welded connection and the secondary locking can have a contact device stop and/or a mechanical locking connection. Furthermore, the secondary locking can also be formed by a press connection, a clip connection, etc. between the pin-contact device and the contact body. In particular, the welded connection can be formed as a spot weld.

The primary locking can be formed as a circumferential portion of the pin-contact assembly. Here, the pin-contact device can be locked at/in the contact body in at least two (for example, defective or intact welded connection) or all three (for example, intact welded connection) translational degrees of freedom. Further, the pin-contact device can be locked at/in the contact body in at least two or all three rotational degrees of freedom. Furthermore, the primary locking can be designed as a welded and possibly circumferential form-fit connection between the pin-contact device and the contact body.

In other words, furthermore, this means that the (entire) ‘primary locking’ (established in the pin-contact assembly) is to be understood as a complete longitudinal extent portion of the pin-contact assembly in which at least this (entire) primary locking of the pin-contact device is located at/in the contact body.

The secondary locking can be formed as a circumferential portion of the pin-contact assembly. Here, the pin-contact device can be locked at/in the contact body in five translational directions or in all three translational degrees of freedom. Further, the pin-contact device can be locked at/in the contact body in at least two or all three rotational degrees of freedom. Furthermore, the secondary locking can be designed as a stop or locking, and possibly at least partial circumferential form-fit connection between the pin-contact device and the contact body.

In other words, furthermore, this means that the (entire) ‘secondary locking’ (established in the pin-contact assembly) is to be understood as a complete longitudinal extent portion of the pin-contact assembly in which at least this (entire) secondary locking of the pin-contact device is located at/in the contact body.

Only the involved locking surfaces of an actual secondary locking itself can lock the pin-contact device in exactly one translational direction or degree of freedom at/in the contact body. Further, this can lock the pin-contact device in no, at least one, or exactly one rotational direction or degree of freedom at/in the contact body. In addition, these locking surfaces can be formed as an actual stop or locking connection between the pin-contact device and the contact body.

An ‘actual secondary locking itself’ is understood to mean merely its cooperating locking surfaces of its involved secondary detent devices; i.e., the locking surfaces without a respective connection and periphery via the respective secondary detent device to/into the pin-contact device and the contact body. In the case of a stop connection, for example, this can be only two mutually associated surfaces of the pin-contact assembly, and in the case of a locking connection, for example, likewise only two mutually associated surfaces or two times two or more mutually associated surfaces.

The mechanical stop connection can be established between a longitudinal end of the pin-contact device and a projection pointing inwards into the contact body. This can be realized, for example, by a protrusion (bead, bulge, latch, etc.) of the contact body pointing inwards into the contact body, or by a tab (wall portion), of the contact body pointing inwards into the contact body, etc.

In the mechanical locking connection, the pin-contact device and the contact body can bear against or mesh with each other. In particular, the mechanical locking connection can be established between an outer side of the pin-contact device and an inner side of the contact body.

The secondary locking can comprise a secondary locking assembly of the pin-contact device and a secondary locking assembly of the contact body. In the secondary locking, the secondary locking assemblies are seated against each other (hardly any play or no play) or can be seated against each other (play). The secondary locking assembly of the pin-contact device can comprise at least one, exactly two, or a plurality of secondary detent devices. The secondary locking assembly of the contact body can similarly have at least one, exactly two, or a plurality of secondary detent devices.

A single secondary detent device of the pin-contact device or of the contact body can be designed here as a stop or a detent device. A detent device can be, for example, a detent protrusion, a locking lug, a locking shoulder, a locking rim, a locking edge, a detent recess, etc. In this case, mutually associated secondary detent devices block or lock the pin-contact device in the contact body or the contact body on the pin-contact device. And of course, if necessary, more than two secondary detent devices can be provided per secondary locking assembly.

Mutually associated secondary detent devices of the pin-contact device and of the contact body can form a stop or a latching in the pin-contact assembly. Here, exactly or at least one such latching can be established in the pin-contact assembly. One (only) such latching is formed, for example, as an engagement of a protrusion in a blind hole. Two such latchings can be directly or diagonally opposite each other in the transverse direction

The at least one secondary detent device of the pin-contact device can be designed as a detent device and the at least one secondary detent device of the contact body can also be designed as a detent device. Thus, for example, no or only a conditional displacement of the pin-contact device with respect to the contact body is possible in the longitudinal direction due to the detent devices of the pin-contact device and the contact body. Such a detent device can be formed, for example, as a shear, an indentation, a tooth, a compression, a bead, a stamping, a cut, a notch, a recess, etc.

Two mutually associated detent devices of the pin-contact device and the contact body can be formed either as detent protrusions or as a detent protrusion and a detent recess. Furthermore, a detent protrusion and/or a detent recess, or a secondary detent device can be formed as a plastic cold forming of the pin-contact device and/or the contact body.

Thus, the at least two secondary detent devices of the pin-contact device can be established as detent recesses or as outwardly directed detent protrusions on opposite longitudinal sides of the pin-contact device. In this case, the detent recesses or the detent protrusions are preferably diagonally opposite one another with respect to the longitudinal direction. A mixed form, i.e., at least one detent recess and at least one detent protrusion, can of course also be used. In particular, such a cold-formed detent protrusion can be formed, for example, as an embossing, a compression, a cut, a relief, etc., and a detent recess can be formed, for example, as an embossing, a compression, a bead, etc.

Furthermore, the at least two secondary detent devices of the contact body can be established as inner detent recesses or inwardly directed detent protrusions on opposite longitudinal sides of the contact body. In this case, the detent recesses or the detent protrusions are preferably diagonally opposite one another with respect to the longitudinal direction. A mixed form, i.e., at least one detent recess and at least one detent protrusion, can of course also be used. In particular, such a cold-formed detent protrusion (inward) or such a cold-formed detent recess (outward) can be formed, for example, as an impression of a shear cut, a bead, etc.

The normal vectors of the locking surfaces of the pin-contact device can be established in opposite directions at/in the pin-contact device. Similarly, the normal vectors of the locking surfaces of the contact body can be established in opposite directions at/in the contact body. In other words, mutually associated normal vectors point towards or away from each other, wherein these do not need to be established in parallel in a single device.

The secondary detent devices of the pin-contact device can be established in opposite directions to each other in the pin-contact assembly. Similarly, the secondary detent devices of the contact body can be established in opposite directions to each other in the pin-contact assembly.—In other words, the secondary detent devices of a single device cannot be brought into alignment by means of translation; a mirroring or a wiring is additionally required for this purpose.

The contact body can have a mechanical receptacle for the pin-contact device. Here, the receptacle, in at least one mounting longitudinal portion, can be formed substantially completely closed in the circumferential direction around the longitudinal direction. In such a mounting longitudinal portion, the contact body can have a bottom wall, two side walls and a top wall, which give the contact body its stability. To close the mounting longitudinal portion completely, a top wall engages in or through a side wall or a side wall engages in or through a top wall (plug-in closure, key-lock principle).

The primary locking can be established between two such mounting longitudinal portions in the contact body. Furthermore, the receptacle can have inner bearing surfaces for the pin-contact assembly that are preferably obliquely opposite one another with respect to the longitudinal direction. Preferably, two such inner bearing surfaces are established on the inside of the receptacle for each longitudinal side. The inner bearing surfaces can be inner surfaces of inner protrusions introduced into the receptacle (cf. above). In addition, a locking surface of a secondary detent device can adjoin an inner bearing surface substantially directly.

The primary locking can be established in a longitudinal extent portion of the pin-contact assembly. Here, the primary locking can be formed by a circumferential portion of the receptacle in which the pin-contact device is received in a sectional manner. Further, in the primary locking, a circumferential tab of the receptacle, a wall of the receptacle, and the pin-contact device can be welded together. Furthermore, a free edge of the circumferential tab and of the wall and, preferably, a corner region of the pin-contact device can be welded to one another in the primary locking.

The contact body can be designed as a contact body that can be latched in a housing. Here, the contact body can have a primary locking assembly and a secondary locking assembly for the pin-contact assembly in the housing.—The primary locking assembly can be formed as a preferably resilient locking lance at the contact body. In this case, the locking lance can protrude from the contact body and can be designed to be resilient with respect to the contact body. Preferably, the locking lance extends substantially in the longitudinal direction and projects upwards (vertical direction) or laterally (transverse direction) from the contact body.

The secondary locking assembly can be designed as a preferably rigid locking edge or locking shoulder at/in the contact body. The locking edge or locking shoulder can form a boundary here of the contact body and can be designed sitting fixedly on the contact body. Preferably, the locking edge or locking shoulder extends here in the transverse direction and/or in the vertical direction.

The pin-contact assembly, which is preferably formed in exactly two parts, can be formed in one piece or materially in one piece.—A one-piece design is understood to mean a design of the pin-contact assembly in which its individual parts (pin-contact assembly and contact body) are secured to one another in a frictionally engaged and/or form-fitting manner and can preferably be separated into their individual parts without damaging one of their individual parts. In the case of a multi-part design, the frictional engagement and/or form fit is (conditionally) absent, or cohesion of the contact assembly is produced by means of a third part.

A materially (adhesive) one-piece design is understood to mean a design of the pin-contact assembly in which its individual parts (pin-contact device and contact body) are secured to each other in a materially bonded manner (welding, soldering, gluing, etc.) and the pin-contact assembly preferably cannot be separated into individual parts without damaging one of its individual parts. The cohesion of the pin-contact assembly can also be produced here by means of a frictional engagement and/or form fit (not in the case of an integral design).

Furthermore, the pin-contact assembly is not integral and preferably not formed at least in three parts.—In the case of an integral design of the pin-contact assembly, there would only be a single component which could only be divided by being destroyed. This component would be made from a single original piece (sheet metal, blank, etc.) and/or a single original mass (metal/plastic melt), which in turn would be forced to be integral. Internal cohesion would be achieved exclusively by means of adhesion and/or cohesion.

The pin-contact device can be designed as a tab-contact device or a pin-contact device. Further, the contact body can have an electrical conductor crimping region and a mechanical insulation crimping region. That is to say, the contact body is designed as a crimpable contact body and the pin-contact assembly is designed as a crimp contact assembly

In an embodiment, an entity is provided including a housing and a two-part, electrical pin-contact assembly received in the housing.—Here, the entity can further comprise, for example, in addition to an entity housing, at least one mechanical, electrical, electronic, optical and/or fluidic device or assembly. Such an entity can (also) be formed, for example, as a device (electrical connector with connector housing as entity housing), an assembly (electrical connector assembly with assembly housing as entity housing), a (pre)assembled cable (with an electrical connector), a subassembly, a printed circuit board, a component, a module, a unit, an apparatus, an aggregate, a plant, a system, etc.

The subject matter herein is explained in greater detail below by means of exemplary embodiments with reference to the attached schematic drawing, which is not to scale. Portions, elements, parts, units, components and/or schemes which have an identical, univocal or analogous design and/or function are marked with the same reference signs in the figure description (see below), the list of reference signs, the claims and in the figures (FIG.) of the drawing. A possible alternative, static and/or kinematic inversion, combination, etc., to the exemplary embodiments or to a component, scheme, unit, part, element or portion thereof, which is not explained in the description (see above), is not shown in the drawing and/or is not conclusive, can further be taken from the list of reference signs and/or the figure description.

A feature (portion, element, part, unit, component, function, size, etc.) can be positive, i.e., present, or negative, i.e., absent. In this specification (description (brief description of invention (see above), figure description (see below)), list of reference signs, claims, drawing) a negative feature is not explicitly explained as a feature, unless according to the subject matter herein it is emphasized that it is absent. That is to say, the subject matter herein actually made and not one constructed by the prior art consists in omitting this feature.

A feature of this specification can be applied not only in a stated manner and/or way, but also in another manner and/or way (isolation, combination, substitution, addition, standalone provision, omission, etc.). In particular, it is possible, on the basis of a reference sign and a feature associated therewith or vice versa, in the description, the list of reference signs, the claims and/or the drawing, to replace, add or omit a feature in the claims and/or the description. In addition, a feature in a claim can thereby be interpreted and/or specified in greater detail.

The features of the description (in view of the (initially mostly unknown) prior art) can also be interpreted as optional features; i.e., each feature can be understood as an optional, arbitrary or preferred, i.e., a non-binding, feature. Thus, it is possible to extract a feature, possibly including its peripherals, from an exemplary embodiment, wherein this feature can then be applied to a generalized concept of the subject matter herein. The absence of a feature (negative feature) in an exemplary embodiment shows that the feature is optional (person skilled in the art) with respect to the subject matter herein, as applicable. Furthermore, in the case of a type term for a feature, a generic term for the feature can also be read along (possibly further hierarchical subdivision into subgenus, etc.), whereby, for example, taking into account equal effect and/or equal value, a generalization of the feature is possible.

### BRIEF DESCRIPTION OF THE DRAWINGS

FIG. 1 shows, in a lateral perspective view obliquely from above, an embodiment of a two-part, electrical pin-contact assembly with a pin-contact device and a contact body in accordance with embodiments herein.

FIG. 2 shows, in a two-dimensional, sectional, and isolated-detail plan view, a secondary locking established between the pin-contact device and the contact body in accordance with embodiments herein.

FIG. 3 shows, in a two-dimensional, sectional, and isolated-detail plan view, a secondary locking established between the pin-contact device and the contact body in accordance with embodiments herein.

FIG. 4 shows a two-dimensional, sectional, and isolated-detail side view of an established primary and secondary latching of a pin-contact assembly in a housing in accordance with embodiments herein.

### DETAILED DESCRIPTION OF THE INVENTION

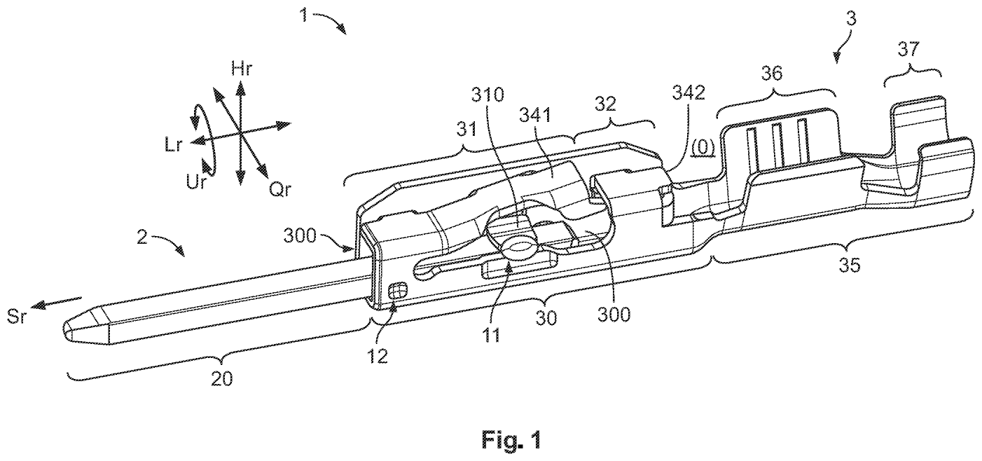

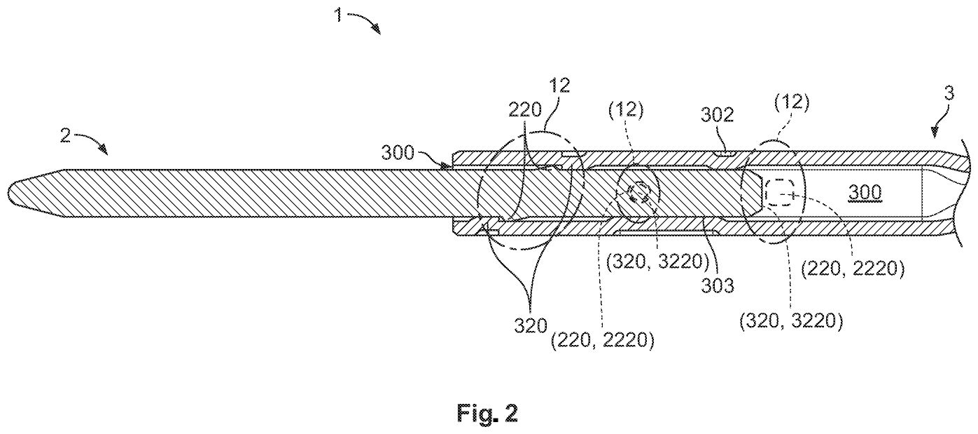

The subject matter herein is explained in greater detail below with reference to examples of three embodiments (FIGS. 1 to 3: first embodiment, solid reference lines, FIG. 2: second and third embodiments, each dashed reference lines) of a variant of a two-part, electrical pin-contact assembly 1, in particular a nano or pico pin-contact assembly 1 for an electrical plug connection in the automotive sector. Although the subject matter herein is described and illustrated in greater detail by preferred exemplary embodiments, the subject matter herein is not limited by the disclosed exemplary embodiments, but is of a more fundamental nature.

Other variations can be derived therefrom and/or from the above (description of the invention) without departing from the scope of protection of the subject matter herein. The subject matter herein is generally applicable in the electrical field in the case of an electrical entity (see above). An exception is ground-based electrical power engineering. In the drawing, only those spatial portions of an object or embodiment are shown which are necessary for an understanding of the subject matter herein. Designations such as connector and mating connector, terminal (cf. above) and counter terminal, etc. are to be interpreted synonymously, i.e., if necessary, can be interchanged with each other.

In the following, the explanation of the subject matter herein with reference to the drawing—see FIG. 1—refers to a longitudinal direction Lr (a selection of which is a plug-in direction Sr), a vertical direction Hr, a transverse direction Qr and a circumferential direction Ur of the pin-contact assembly 1. Here, the longitudinal direction Lr corresponds to the main direction of extent of the pin-contact assembly 1, the vertical direction Hr substantially corresponds to a spring direction of a locking lance 341 of the pin-contact assembly 1, and the transverse direction Qr substantially corresponds to a direction of extent of a locking edge or locking shoulder of the locking lance 341. Additionally, the circumferential direction Ur runs around the longitudinal direction Lr.

FIG. 1 shows an exemplary embodiment of the two-part electrical pin-contact assembly 1. The pin-contact assembly 1 is preferably formed here materially in one piece, but can also be formed just in one piece, i.e., without a material connection. The pin-contact assembly 1 can be provided, in particular can be latched, for example in a housing 0 (cf. FIG. 4), for example a connector housing 0, an entity housing 0, etc. Preferably, a primary locking 41 and preferably also a secondary locking 42 are used for this purpose between the pin-contact assembly 1 and the housing 0.

The present pin-contact assembly 1 comprises, in the present case, as a first part an electrical pin-contact device 2 and as a second part an electrical contact body 3. The pin-contact device 2 can be formed here as a straight pin 2, a straight tab 2, etc. What further distinguishes the pin-contact device 2 is that it is not formed as a socket and preferably has a solid material cross-section.

The pin-contact assembly 1 is divided into an electrical contact portion 20 (a portion of the pin-contact device 2), a mechanical latching portion 30 (substantially a portion of the contact body 3), and an electromechanical cable connection portion 35 (a portion of the contact body 3). The latching portion 30 is further divided into a primary locking region 31 for the primary locking 41 and a secondary locking region 32 for the secondary locking 42. In addition, the cable terminal portion 35 is further divided into an electrical conductor crimping region 36 and a mechanical insulation crimping region 37 for an electrical cable (not shown).

In the present case, the pin-contact device 2 is designed as a simple pin-contact device 2 with a square cross-section. Another cross-section such as an elliptical, circular, rectangular or polygonal cross-section is of course useable. That is to say, of course, another contact device 2, such as a tab-contact device 2, etc., is also useable. The pin-contact device 2 has substantially the shape of a straight solid cylinder with a substantially regular cross-section as well as preferably insertion slopes at its longitudinal end portions.

The contact body 3 has, in its latching portion 30, a receptacle 300 for the pin-contact device 2, in which the pin-contact device 2 is received and secured. The receptacle 300 is designed to be completely closed at its front and rear longitudinal end portions in the circumferential direction Ur. Here, the respective longitudinal end portion comprises a bottom wall, two side walls, and a top wall, the top wall being plugged, for locking purposes, into the side wall, which preferably extends along substantially the entire latching portion 30. The side wall opposite in the transverse direction Qr and the bottom wall preferably also extend substantially along the entire latching portion 30. The top wall is interrupted here.

A primary locking assembly 341 of the contact body 3 is established between the two longitudinal end portions of the receptacle 300, which are each completely closed in the circumferential direction Ur. In this case, the primary locking assembly 341 is designed as a locking lance 341 which is preferably resilient in the vertical direction Hr, cf. also FIG. 4. In this case, the locking lance 341 extends integrally from the front closed longitudinal end portion in the longitudinal direction Lr substantially to the rear and somewhat in the vertical direction Hr. In this case, the locking lance 341 can be guided with a protrusion projecting away from it in the transverse direction Qr in a window of a side wall adjacent to it. At its free longitudinal end, the locking lance 341 can have a detent protrusion.

Furthermore, cf. also FIG. 4, the rear region of the rear longitudinal end portion of the receptacle 300, which is completely closed in the circumferential direction Ur, is formed as a secondary locking assembly 342. Here, the secondary locking assembly 342 is preferably formed as a rigid locking shoulder 342. The rigid locking shoulder 342 preferably extends substantially in the transverse direction Qr and optionally in the vertical direction Hr.

In addition, an electrical and mechanical primary locking 11 of the contact device 2 with the contact body 3 is preferably established in the vertical direction Hr below the primary locking 341, i.e., in the direction of the receptacle 300. Here, the primary locking 11 is formed as a preferably substantially complete circumferential form-fit connection of the contact body 3 around the pin-contact device 2 (cf. longitudinal portion at the top), the pin-contact device 2 being secured by means of a materially bonded connection, in particular a welded connection, in the longitudinal direction Lr. In other words, a translational displacement of the contact device 2 is not possible with the material connection intact.

The circumferential form-fit connection is constituted by longitudinal portions of the base wall and the two side walls as well as by a circumferential tab 310 (longitudinal portion, cover) of the receptacle 300, the pin-contact device 2 being accommodated between these portions in a substantially form-fitting manner. The circumferential tab 310 is bent here, starting from one side wall, towards the side wall opposite thereto. The materially bonded connection, in particular the welded connection, is established in a transition portion of a free end of the circumferential tab 310 and the side wall associated therewith.

In particular, the materially bonded connection fastens the free end of the circumferential tab 310, a free edge of the side wall associated with this end, and the pin-contact device 2 to one another. The pin-contact device 2 is firmly connected here to the contact body 3, in particular by one of its corner regions.—An alternative primary locking 11, such as a latching, a press fit, etc., is of course useable.

Within the receptacle 300, the pin-contact device 2 is preferably received between inner bearing surfaces 303 and is seated against these. The inner bearing surfaces 303 project inwardly here into the receptacle 300 and are formed by inner protrusions of the receptacle 300. Here, the inner bearing surfaces 303 are preferably introduced into the side walls of the receptacle 300 by impressions of shear cuts. Preferably, two such inner bearing surfaces 303 are provided per side wall. A different number of inner bearing surfaces per side wall, in particular a single one or more than two, are of course useable. Of course, an odd number of inner bearing surfaces 303 can also be provided internally on one side wall and an even number on the opposite side wall.

To secure the primary locking 11 or the material bond between the pin-contact device 2 and the contact body 3, i.e., in the event of a possible at least partial failure of the material bond, the pin-contact assembly 1 has an established, preferably electrical and in particular mechanical secondary locking 12. Here, the secondary locking 12 locks the pin-contact device 2 at/in the contact body 3, in particular in the receptacle 300.

Three embodiments of such a secondary locking 12 are shown here; cf. in particular FIG. 2. Other embodiments are of course useable. For example, FIG. 2 shows, on the left and in the middle of a connection region between the pin-contact device 2 and the contact body 3, in each case a locking connection of the pin-contact device 2 to the contact body 3 and, on the right, a contact device stop of the pin-contact device 2 at/in the contact body 3. The middle locking connection of FIG. 2 can also be described as an engagement connection.—All of these mechanical connections can also be referred to as mechanical seating connections (cf. above).

In the seating connection in the center of FIG. 2, a protrusion engages in a recess. A protrusion of the pin-contact device 2 can engage here in a recess of the contact body 3 or, vice versa, a protrusion of the contact body 3 can engage in a recess of the pin-contact device 2.—In the seating connection on the right in FIG. 2, a free end of the pin-contact device 2 can sit on a protrusion in the receptacle 300 of the contact body 3. This protrusion can be formed, for example, as a bead, a tab bent out from the contact body 3, etc.

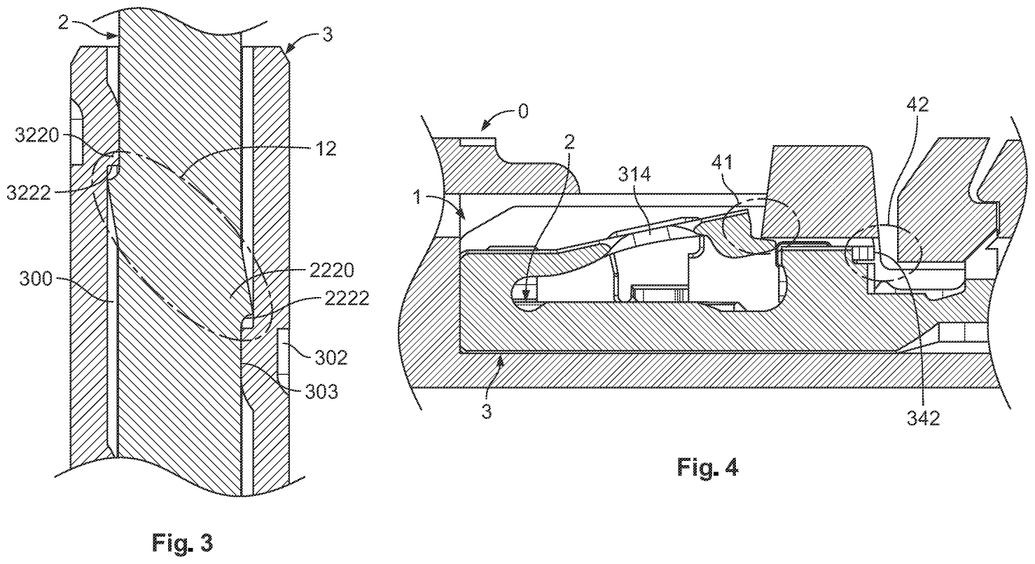

The seating connection on the left in FIG. 2, see also FIG. 3, is designed as a locking connection. Here, the pin-contact device 2 has a secondary locking assembly 220 and the contact body 3 also has a secondary locking assembly 320. The secondary locking assemblies 220, 320 are designed to be complementary in portions and, in a mounted state of the pin-contact device 2 in the receptacle 300, are preferably seated against one another with some play (FIG. 3).—In the present case, the relevant secondary locking assembly 220, 320 comprises two secondary locking assemblies 2220, 3220, each having a locking surface 2222, 3222. The respective secondary detent device 2220, 3220 can be formed, for example, as a detent protrusion, a locking lug, a locking shoulder, a locking rim, a locking edge, a detent recess, etc.

In the established secondary locking 12, two secondary mutually associated detent devices 2220/3220 or two mutually associated locking surfaces 2222/3222 block the pin-contact device 2 in only a single translational direction at/in the contact body 3. Therefore, two times two mutually associated secondary detent devices 2220/3220 are preferably established in the pin-contact assembly 1 in such a way that the pin-contact device 2, apart from the primary locking 11, is held or blocked at/in the contact body 3 in both translational directions still possible for it (i.e., a complete translational degree of freedom).

Here, the secondary detent devices 2220 of the pin-contact device 2 and the secondary detent devices 3220 of the contact body 3 are established in opposite directions to each other in the pin-contact assembly 1. That is to say, not only do the mutually associated locking surfaces 2222/3222 of two mutually associated secondary detent devices 2220/3220 face each other, but the locking surfaces 2222/2222 of the pin-contact device 2 and the locking surfaces 3222/3222 of the contact body 3 also face each other in the pin-contact assembly 1.

Here, the two secondary detent devices 2220 or the two locking surfaces 2222 of the pin-contact device 2 are established on sides of the pin-contact device 2 that are preferably opposite each other in the transverse direction Qr. Furthermore, the two secondary devices 2220 or the two locking surfaces 2222 of the pin-contact device 2 are established offset from one another in the longitudinal direction Lr at/in the pin-contact device 2.—This of course applies analogously to the contact body 3 or the receptacle 300 internally.

It is of course possible to use other secondary detent devices 2220, 3220, for example, in addition to a detent protrusion 2220/3220 a detent recess 3220/2220. Furthermore, it is possible to provide the secondary detent devices 2220, 3220, for example, on a single side, three sides or four sides. In addition, it is possible to establish the secondary detent devices 2220, 3220 in the pin-contact assembly 1 in such a way that the pin-contact device 2 does not have to be set up polarized or oriented or can be set up polarized or oriented in two or three rotational positions in the contact body 3.

FIG. 4 further shows an established primary locking 41 and an established secondary locking 42 of the pin-contact assembly 1 with the housing 0. Here, the locking lance 314 bears against an internal protrusion of the housing 0, thus forming the primary locking 41. Further, the secondary locking assembly 342 can also be seated within the housing 0. In this case, a rotationally or translationally movable protrusion of the housing 0 or of a part external to the housing can bear against a corresponding region on the secondary locking assembly 342 of the pin-contact assembly 1, thus forming the secondary locking 41.

In a two-part prior art pin-contact assembly, only one weld spot serves to secure (lock) the pin-contact assembly in the longitudinal direction. If this weld point is imperfect or defectively formed, it can come loose before or during use of the pin-contact assembly in a vehicle. This means that longitudinal positioning of the pin-contact device in the pin-contact assembly is not ensured, which can lead to failure of an electrical contact.

Various embodiments provide, for example, in addition to a weld spot of a primary locking 11 of a pin-contact device 2 on/in a contact body 3, an additional positioning or securing. This is formed as a secondary locking 12 of the pin-contact device 2 at/in the contact body 3 or in the pin-contact assembly 1. Thus, in the event of a faulty or defective weld spot, the pin-contact device 2 cannot emerge from the contact body 3 or can be pushed too far into it. Thus, electrical contact between the pin-contact assembly 1 and a socket terminal (not shown) is ensured even in the event of a faulty or defective weld spot in the pin-contact assembly 1.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A two-part electrical pin-contact assembly for an electrical plug-in connection in the automotive sector comprising:
a pin-contact device extending in a longitudinal direction; and
a contact body extending in said longitudinal direction;
wherein the pin-contact device is received in the contact body and secured to the contact body by a primary locking and a secondary locking.

2. The two-part pin-contact assembly of claim 1, wherein the secondary locking is formed that, in the event of a failure of the primary locking, the secondary locking takes over securing of the pin-contact device to the contact body.

3. The two-part pin-contact assembly of claim 1, wherein the primary locking includes at least one of a materially bonded connection or a welded connection between the pin-contact device and the contact body, and wherein the secondary locking includes at least one of a mechanical seating connection or a contact device stop or a mechanical locking connection between the pin-contact device and the contact body.

4. The two-part pin-contact assembly of claim 1, wherein the primary locking is a circumferential portion, the circumferential portion being formed as at least one of a welded connection and a circumferential form-fit connection between the pin-contact device and the contact body, the pin-contact device being locked in at least two translational degrees of freedom in the contact body by the circumferential portion, the pin-contact device being locked in at least two rotational degrees of freedom in the contact body by the circumferential portion.

5. The two-part pin-contact assembly of claim 1, wherein the secondary locking is formed as a circumferential portion, the circumferential portion being formed as at least one of a stop connection, a locking connection and a form-fit connection between the pin-contact device and the contact body, the pin-contact device being locked in at least two translational directions in the contact body by the circumferential portion, the pin-contact device being locked in at least two rotational degrees of freedom in the contact body.

6. The two-part pin-contact assembly of claim 1, wherein the secondary locking includes a locking surface that locks the pin-contact device in exactly one translational direction in the contact body.

7. The two-part pin-contact assembly of claim 1, wherein the secondary locking includes a mechanical connection between an outer side of the pin-contact device and an inner side of the contact body, the mechanical connection being established between a longitudinal end of the pin-contact device and a projection facing inwardly into the contact body, the mechanical connection between the pin-contact device and the contact body meshing with each other to position the pin-contact device in the contact body.

8. The two-part pin-contact assembly of claim 1, wherein the secondary locking includes a secondary detent device defining a secondary locking assembly of the pin-contact device and a secondary detent device defining a secondary locking assembly of the contact body, the secondary detent devices being seated against one another to position the pin-contact device in the contact body.

9. The two-part pin-contact assembly of claim 8, wherein the two mutually associated detent devices of the pin-contact device and of the contact body are formed as a detent protrusion and a detent recess.

10. The two-part pin-contact assembly of claim 1, wherein the secondary locking includes locking surfaces of the pin-contact device and locking surfaces of the contact body, normal vectors of the locking surfaces of the pin-contact device are set up in opposite directions, normal vectors of the locking surfaces of the contact body are set up in opposite directions.

11. The two-part pin-contact assembly of claim 1, wherein the contact body includes a receptacle receiving the pin-contact device, the receptacle includes mounting longitudinal portions spaced apart along the longitudinal direction, the receptacle being formed substantially completely closed in the circumferential direction, the primary locking is established between two such mounting longitudinal portions in the contact body, the receptacle includes inner bearing surfaces obliquely opposite one another with respect to the longitudinal direction, the pin-contact device including a locking surface adjoining the corresponding inner bearing surface.

12. The two-part pin-contact assembly of claim 1, wherein the primary locking is established in a longitudinal extent portion of the pin-contact assembly, the primary locking being formed by a circumferential portion of the contact body, the primary locking including a circumferential tab, wherein a free edge of the circumferential tab is welded to a wall of the contact body and a corner region of the pin-contact device to secure the pin-contact device in the contact body.

13. The two-part pin-contact assembly of claim 1, wherein the contact body includes a primary locking assembly and a secondary locking assembly configured to be secured in a housing, the primary locking assembly including a resilient locking lance, the secondary locking assembly including rigid locking shoulder.

14. The two-part pin-contact assembly of claim 1, wherein the contact body includes an electrical conductor crimping region and a mechanical insulation crimping region.

15. An electrical entity comprising:
a housing having a chamber; and
a two-part electrical pin-contact assembly received in the chamber, the two-part electrical pin-contact assembly including a pin-contact device extending in a longitudinal direction and a contact body extending in said longitudinal direction, wherein the pin-contact device is received in the contact body and secured to the contact body by a primary locking and a secondary locking.

16. The electrical entity of claim 15, wherein the primary locking includes at least one of a materially bonded connection or a welded connection between the pin-contact device and the contact body, and wherein the secondary locking includes at least one of a mechanical seating connection or a contact device stop or a mechanical locking connection between the pin-contact device and the contact body.

17. The electrical entity of claim 15, wherein the primary locking is a circumferential portion, the circumferential portion being formed as at least one of a welded connection and a circumferential form-fit connection between the pin-contact device and the contact body, the pin-contact device being locked in at least two translational degrees of freedom in the contact body by the circumferential portion, the pin-contact device being locked in at least two rotational degrees of freedom in the contact body by the circumferential portion.

18. The electrical entity of claim 15, wherein the secondary locking includes a mechanical connection between an outer side of the pin-contact device and an inner side of the contact body, the mechanical connection being established between a longitudinal end of the pin-contact device and a projection facing inwardly into the contact body, the mechanical connection between the pin-contact device and the contact body meshing with each other to position the pin-contact device in the contact body.

19. The electrical entity of claim 15, wherein the secondary locking includes a secondary detent device defining a secondary locking assembly of the pin-contact device and secondary detent device defining a secondary locking assembly of the contact body, the secondary detent devices being seated against one another to position the pin-contact device in the contact body.

20. The electrical entity of claim 15, wherein the contact body includes a primary locking assembly and a secondary locking assembly configured to be secured in the housing, the primary locking assembly including a resilient locking lance engaging the housing, the secondary locking assembly including rigid locking shoulder engaging the housing.
